(19) United States
(12) Patent Application Publication
(10) Pub. No.: US 2021/0334649 A1
(43) Pub. Date: Oct. 28, 2021

(54) APPARATUS AND METHOD FOR DISTRIBUTED REINFORCEMENT LEARNING

(71) Applicant: INDUSTRY-ACADEMIC COOPERATION FOUNDATION, YONSEI UNIVERSITY, Seoul (KR)

(72) Inventors: Seong-Lyun KIM, Seoul (KR); Han CHA, Seoul (KR)

(73) Assignee: INDUSTRY-ACADEMIC COOPERATION FOUNDATION YONSEI UNIVERSITY

(21) Appl. No.: 17/125,986

(22) Filed: Dec. 17, 2020

(30) Foreign Application Priority Data
Apr. 24, 2020 (KR) 10-2020-0050049

(51) Int. Cl. G06N 3/08; G06N 3/04

(52) U.S. Cl. CPC G06N 3/08; G06N 3/04

(57) ABSTRACT

An apparatus for distributed reinforcement learning includes: a local neural network for receiving state information regarding a surrounding environment and estimating an action execution probability from the state information according to a previously learned pattern estimation method; a loss estimation unit for applying learning to the local neural network by estimating a loss value from the action execution probability and a global action execution probability transmitted from a central server; a local experience memory for mapping and storing the state information and the action execution probability; a clustering unit for clustering the state information stored in the local experience memory according to a pre-designated method to classify the state information into state clusters having proxy state information configured beforehand; and a local proxy memory for mapping and storing the proxy state information and proxy action execution probability corresponding to each state cluster for transmitting to the central server.

### CROSS-REFERENCE TO RELATED APPLICATIONS

This application claims priority under 35 U.S.C. § 119(a) to Korean Patent Application No. 10-2020-0050049, filed with the Korean Intellectual Property Office on Apr. 24, 2020, the disclosure of which is incorporated herein by reference in its entirety.

### BACKGROUND

### 1. Technical Field

The present disclosure relates to an apparatus and a method for distributed reinforcement learning, more particularly to an apparatus and a method for distributed reinforcement learning that can reduce communication costs and protect privacy.

### 2. Description of the Related Art

With recent advances in mobile devices, areas of application for intelligent autonomous systems are expanding, as in the areas of driverless vehicles, drones, and self-controlled robots for smart factories. Devices that use such intelligent autonomous systems must interact with their surrounding environments and take decision making measures in real time.

Currently, such intelligent autonomous systems are in many cases implemented by artificial neural networks, and in order for an intelligent autonomous system implemented by an artificial neural network to function normally, it must undergo a learning process. Here, in order for devices employing intelligent autonomous systems to operate in a stable manner, a large amount of information is needed as regards the results of interactions in various environments. However, it is realistically very difficult for individual devices to obtain large amounts of learning information individually. To overcome this limit, the distributed reinforcement learning technique (also known as the distributed prioritized experience replay technique) has been proposed.

In distributed reinforcement learning, a multiple number of devices operate as multiple agents that perform reinforced learning within the intelligent autonomous system and exchange the knowledge obtained as results of interactions in their respective environments as learning information of a designated format referred to as an experience replay memory, so that large amounts of learning information may be readily obtained for learning.

Here, to allow the multiple agents to efficiently exchange the information stored in the experience replay memory, distributed reinforcement learning generally utilizes a central server that collects the information obtained by each of the multiple agents in the experience replay memory and redistributes the collected information to each of the agents.

When a distributed reinforcement learning method is used, large amounts of learning information can be readily obtained to provide high performance, as the knowledge obtained individually by each of the multiple agents can be used commonly for learning. However, since the multiple agents have to transmit the information stored in the experience replay memory to the central server, and the central server has to collect the transmitted information and redistribute the information again to each of the multiple agents, there is the problem that the amount of communication traffic is greatly increased due to the transmissions of large amounts of experience replay memory. Furthermore, the information stored in the experience replay memory transmitted by each of the multiple agents includes various information, including the status information of each agent and corresponding information on the various operations performed, highlighting the limit in being unable to protect the individual information of each agent.

### SUMMARY

An objective of the disclosure is to provide an apparatus and a method for distributed reinforcement learning that can reduce communication costs by decreasing the sizes of experience replay memory.

Another objective of the disclosure is to provide an apparatus and a method for distributed reinforcement learning that can protect the individual information of each agent when experience replay memory is exchanged.

An embodiment of the disclosure conceived to achieve the objectives above provides an apparatus for distributed reinforcement learning that includes: a local neural network configured to receive state information regarding a surrounding environment and estimate an action execution probability from the state information according to a previously learned pattern estimation method, where the action execution probability probabilistically represents an action to be executed; a loss estimation unit configured to apply learning to the local neural network by estimating a loss value from the action execution probability and a global action execution probability transmitted from a central server; a local experience memory configured to store the state information and the action execution probability estimated in correspondence to the state information, with the state information and the action execution probability stored mapped to each other; a clustering unit configured to cluster multiple pieces of state information stored in the local experience memory according to a pre-designated method to classify the pieces of state information into at least one state cluster having a piece of proxy state information configured beforehand, where the clustering unit is configured to obtain a proxy action execution probability for each state cluster from an action execution probability mapped correspondingly to each piece of state information included in the at least one state cluster; and a local proxy memory configured to map and store the proxy state information and proxy action execution probability corresponding to each of the at least one state cluster for transmitting to the central server.

The clustering unit can obtain the proxy action execution probability by calculating a statistics value in a pre-designated manner for action execution probabilities mapped to each of at least one piece of state information included in each of the at least one state cluster.

The apparatus for distributed reinforcement learning can transmit proxy action execution probabilities stored during a pre-designated condition segment together with the mapped proxy state information to the central server.

The apparatus for distributed reinforcement learning can transmit an identifier of the at least one state cluster together with the proxy action execution probability to the central server, where the identifier can be configured to represent the proxy state information.

The global action execution probability can be obtained by the central server as a statistics value calculated in a pre-designated manner for a multiple number of proxy action execution probabilities obtained by a multiple number of distributed reinforcement learning apparatuses in correspondence to each of at least one cluster, and the global action execution probability can be transmitted to the multiple number of distributed reinforcement learning apparatuses.

Another embodiment of the disclosure conceived to achieve the objectives above provides an apparatus for distributed reinforcement learning that includes: a global experience memory configured to receive and store at least one piece of proxy state information and at least one proxy action execution probability, where the at least one piece of proxy state information, which may be configured in correspondence to at least one pre-designated state cluster, and the at least one proxy action execution probability, which may be mapped in correspondence to the at least one piece of proxy state information, are received from a multiple number of agents; a global computation unit configured to compute a global action execution probability in a pre-designated manner from the at least one proxy action execution probability mapped correspondingly to the at least one piece of proxy state information stored in the global experience memory; and a global proxy experience memory configured to map and store the computed global action execution probability for redistributing transmission to each of the multiple agents, where the global action execution probability may be stored mapped correspondingly to the at least one piece of proxy state information.

Still another embodiment of the disclosure conceived to achieve the objectives above provides a method for distributed reinforcement learning that includes: receiving state information and estimating an action execution probability from the state information according to a previously learned pattern estimation method, where the state information represents the state of a surrounding environment, and the action execution probability probabilistically represents an action to be executed; learning a pattern estimation method for estimating the action execution probability by determining a loss value from the action execution probability and a global action execution probability transmitted from a central server; storing the state information and the action execution probability corresponding to the state information in a mapped form; clustering multiple pieces of state information in a pre-designated manner to classify the multiple pieces of state information into at least one state cluster having a piece of proxy state information configured therefor beforehand, and obtaining a proxy action execution probability for each state cluster from action execution probabilities mapped correspondingly to pieces of state information included in the at least one state cluster; and storing the proxy state information and proxy action execution probability corresponding to each of the at least one state cluster in a mapped form for transmitting to the central server.

Yet another embodiment of the disclosure conceived to achieve the objectives above provides a method for distributed reinforcement learning that includes: receiving and storing at least one piece of proxy state information configured in correspondence to at least one pre-designated state cluster and at least one proxy action execution probability mapped in correspondence to the at least one piece of proxy state information, where the at least one piece of proxy state information and the at least one proxy action execution probability may be received from a multiple number of agents; computing a global action execution probability in a pre-designated manner from the stored at least one proxy action execution probability mapped correspondingly to the at least one piece of proxy state information; and storing the global action execution probability computed for each of the at least one piece of proxy state information in a mapped form for redistributing transmission to each of the multiple agents.

Thus, an apparatus and a method for distributed reinforcement learning according to certain embodiments of the disclosure, by clustering similar experience replay memories into the same clusters, transmitting proxy experience replay memories to the central server after generating the proxy experience replay memories based on the clusters, and applying learning with the proxy experience replay memories received from the server, can greatly reduce the amount of communication traffic as well as protect the individual information of each agent.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 conceptually illustrates the overall structure of a distributed reinforced learning system.

FIG. 2 illustrates a cartpole game as an example of a goal of the learning performed by the distributed reinforced learning system of FIG. 1.

FIG. 3 conceptually illustrates the overall structure of a distributed reinforced learning system according to an embodiment of the disclosure.

FIG. 4 and FIG. 5 illustrate a method for distributed reinforced learning according to an embodiment of the disclosure.

### DETAILED DESCRIPTION

To sufficiently understand the present invention, its advantages, and the objectives achieved by practice of the invention, it is necessary to refer to the appended drawings which illustrate preferred embodiments of the disclosure as well as the descriptions provided for the appended drawings.

The present disclosure is described in detail below, through a description of preferred embodiments of the disclosure with reference to the accompanying drawings. However, the disclosure can be implemented in various different forms and is not limited to the described embodiments. For a clearer understanding of the disclosure, parts that are not of great relevance to the disclosure have been omitted, and like reference numerals in the drawings are used to represent like elements.

Throughout the specification, reference to a part “including” or “comprising” an element does not preclude the existence of one or more other elements and can mean other elements are further included, unless there is specific mention to the contrary. Also, terms such as “unit”, “device”, “module”, “block”, etc., refer to units for processing at least one function or operation, where such units can be implemented as hardware, software, or a combination of hardware and software.

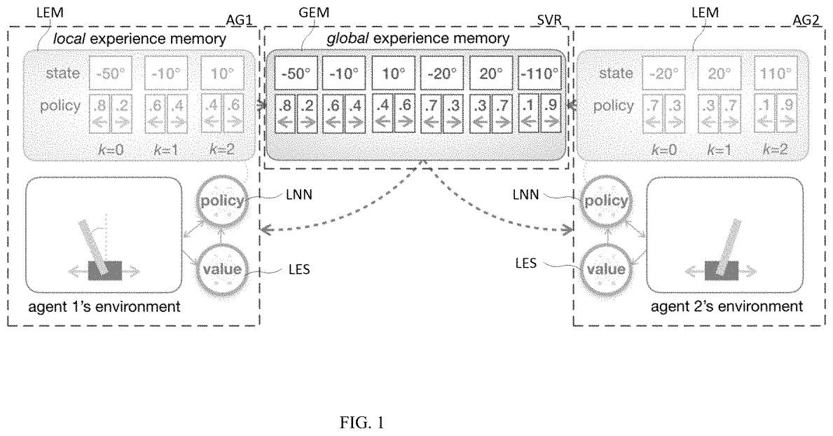

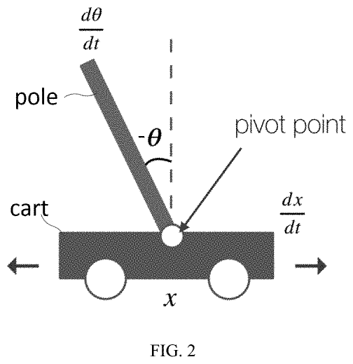

FIG. 1 conceptually illustrates the overall structure of a distributed reinforced learning system, and FIG. 2 illustrates a cartpole game as an example of a goal of the learning performed by the distributed reinforced learning system of FIG. 1.

Referring to FIG. 1 and FIG. 2, a distributed reinforced learning system may include a central server SVR and a multiple number of agents AG1, AG2.

Each of the multiple agents AG1, AG2 may obtain state information regarding a surrounding environment from a corresponding device and, according to the state information thus obtained and based on a pattern estimation scheme learned up until then, may estimate action execution probabilities, which represent probabilistically actions that the device should execute. In a distributed reinforcement learning technique, an action execution probability is also referred to as a ‘policy’.

Each of the multiple agents AG1, AG2 may prompt the device to execute a corresponding action based on the action execution probabilities (policy) estimated according to the obtained state information (state) and, when the action execution probabilities estimated by other agents according to their respective state information (state) are received from the central server SVR, may estimate a loss value (value) based on the obtained state information (state) and action execution probabilities (policy) and the state information (state) and action execution probabilities (policy) transferred from the central server SVR to perform reinforced learning.

Here, in the distributed reinforced learning technique, each of the multiple agents AG1, AG2 may use not only the state information (state) and the action execution probabilities (policy) estimated according to the state information (state) acquired by itself but also the state information (state) and estimated action execution probabilities (policy) acquired by other agents, as these are received through the central server SVR, to estimate the action execution probabilities (policy) corresponding to various state information (state) in the future. In other words, the learning may be performed by using the state information (state) and estimated action execution probabilities (policy) of other agents as well.

Thus, each of the multiple agents AG1, AG2 can include a local neural network LNN and a loss estimation unit LES. The local neural network LNN may be an artificial neural network that estimates the action execution probabilities (policy) according to the obtained state information (state), and the loss estimation unit LES may estimate the loss value (value) based on the action execution probabilities (policy) estimated by the local neural network LNN and the state information (state) and action execution probabilities (policy) transferred from the central server SVR, to perform reinforced learning for the local neural network LNN. Here, the local neural network LNN for estimating the action execution probabilities (policy) is also referred to as an ‘actor’, while the loss estimation unit LES for estimating the loss value for the learning is also referred to as a ‘critic’.

Each of the multiple agents AG1, AG2 may further include a local experience memory LEM that stores the obtained pieces of state information (state) and the correspondingly estimated action execution probabilities (policy) in a mapped form. The local experience memory LEM may be an element analogous to the experience replay memory described above and may be provided to store the multiple pieces of state information (state) and their corresponding action execution probabilities (policy) as well as to transmit the stored multiple pieces of state information (state) and action execution probabilities (policy) to the central server SVR. The local experience memory LEM can store the pieces of state information (state) and their corresponding action execution probabilities (policy) of a pre-designated condition segment, with each piece of state information (state) and its corresponding action execution probabilities (policy) mapped to each other. Here, the pre-designated condition segment can be set in various ways with respect to time or a particular condition.

For instance, consider a device performing a cartpole game such as that shown in FIG. 2. A cartpole game refers to a game in which the cart has to be moved in a way that prevents the pole standing upright on the cart from falling. Here, it is supposed that the lower end of the pole is coupled to a pivot point on an upper surface of the cart, the pole can only fall by rotating in the direction of the x axis, and the device can move the cart in the direction of the x axis at a pre-designated speed.

A device performing the cartpole game can obtain the angle θ rotated by the pole coupled at the pivot point from a direction normal to the upper surface of the cart as state information (state) and can provide this to a corresponding agent. Then, the agent may estimate the action execution probabilities (policy) according to the state information (state) and transfer the action (action) determined according to the estimated action execution probabilities (policy) to the device, prompting the device to execute the corresponding action.

In the example of FIG. 1, it is supposed that the pieces of state information (state) obtained in a pre-designated interval until the cartpole game is finished and the action execution probabilities (policy) corresponding to each piece of state information (state) are mapped to each other and stored in the local experience memory LEM, and as such, FIG. 1 shows the local experience memory LEM of a first agent AG1 storing the state information (state) for three states (k=0, 1, 2) and the action execution probabilities (policy) corresponding to the respective state information (state) in a mapped form.

As illustrated in FIG. 1, multiple action execution probabilities (policy) can be mapped to each piece of state information (state), rather than just one action execution probability (policy) for each piece of state information (state). For instance, in the local experience memory LEM of the first agent AG1, there are two action execution probabilities (policy), i.e. a leftward movement probability of 0.8 and a rightward movement probability of 0.2, mapped for the state information of the pole being at −50° (state k=0) and two action execution probabilities (policy), i.e. a leftward movement probability of 0.4 and a rightward movement probability of 0.6, mapped for the state information of the pole being at 10° (state k=2).

The central server SVR may receive the multiple pieces of state information (state) and their corresponding action execution probabilities (policy) stored in the local experience memory LEM of each of the multiple agents AG1, AG2 and store these in a global experience memory GEM. The multiple pieces of state information (state) and action execution probabilities (policy) stored in the global experience memory GEM may be redistributed back to each of the multiple agents AG1, AG2.

That is, the central server SVR may collect the pieces of state information (state) and action execution probabilities (policy) obtained from each of the multiple agents AG1, AG2 and redistribute the collected pieces of state information (state) and action execution probabilities (policy) back to the multiple agents AG1, AG2, thereby allowing the multiple agents AG1, AG2 to mutually share and commonly use the state information (state) and action execution probabilities (policy), which serve as learning information.

However, in this case, since the multiple agents AG1, AG2 each transmit large amounts of obtained state information (state) and action execution probabilities (policy) to the central server SVR, and the central server SVR again transmits the large amounts of state information (state) and action execution probabilities (policy) collected from the multiple agents AG1, AG2 back to each of the multiple agents AG1, AG2, a very large amount of communication traffic may be incurred. While FIG. 1 illustrates only two agents AG1, AG2 for the sake of convenience, a distributed reinforced learning system can include a large number of agents. This can incur high communication costs. Furthermore, as each of the multiple agents AG1, AG2 transmits the state information (state) obtained by itself and the corresponding action execution probabilities (policy) as is to the central server SVR, the individual information of each of the agents AG1, AG2 is not protected.

Although the above description uses a device performing a simple cartpole game as an example, certain devices that include agents can possibly include important information that warrants protection, and there is a need to protect the individual information obtained by each of the agents AG1, AG2.

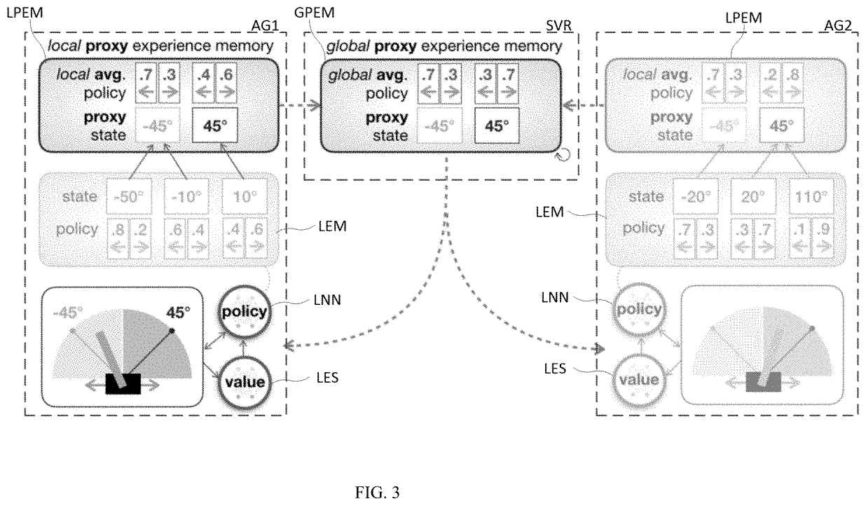

FIG. 3 conceptually illustrates the overall structure of a distributed reinforced learning system according to an embodiment of the disclosure.

Referring to FIG. 3, a distributed reinforced learning system according to this embodiment may include a central server SVR and multiple agents AG1, AG2, similarly to the distributed reinforced learning system of FIG. 1. Each of the multiple agents AG1, AG2 may include a local neural network LNN that estimates action execution probabilities (policy) according to the obtained state information (state), a clustering unit (not shown), a loss estimation unit LES, and a local experience memory LEM that stores the obtained pieces state information (state) and their corresponding action execution probabilities (policy) in a mapped form.

The agents AG1, AG2 of FIG. 3, similarly to the agents AG1, AG2 of FIG. 1, may include local neural networks LNN and local experience memories LEM, and since the operations of the local neural networks LNN and the local experience memories LEM are the same as for FIG. 1, redundant descriptions will be omitted here.

However, the multiple agents AG1, AG2 according to this embodiment may each further include a clustering unit (not shown) and a local proxy experience memory LPEM.

The clustering unit may analyze the multiple pieces of state information (state) stored in the local experience memory LEM to classify the multiple pieces of state information (state) into pre-designated ranges, cluster the pieces of state information (state) classified into the same ranges as state clusters, and configure a piece of proxy state information (proxy state) for each state cluster.

The clustering unit may apply a computation of a pre-designated method to obtain a proxy action execution probability (proxy policy) corresponding to each of the pieces of proxy state information (proxy state) from the action execution probabilities (policy) corresponding to the pieces of state information (state) included in each cluster and may store the pieces of proxy state information (proxy state) and their corresponding proxy action execution probabilities (proxy policy) in a mapped form in the local proxy experience memory LPEM.

Here, a proxy action execution probability (proxy policy) can be obtained, for instance, by applying a statistics operation such as averaging the action execution probabilities (policy) corresponding to the pieces of state information (state) included in the cluster or by applying a weighted average, etc., for the pieces of state information (state) or by another computation of a pre-designated method. In the descriptions that follow, it will be supposed that the proxy action execution probabilities (proxy policy) are obtained by calculating the average values of the action execution probabilities (policy).

In FIG. 3, an example is illustrated in which the clustering unit has clustered the multiple pieces of state information (state) into two state clusters, by dividing the state information into cases where the pole is on the left side and on the right side with respect to the direction normal to the upper surface of the cart, and has set the proxy state information (proxy state) for each state cluster as −45° and 45°.

Thus, it can be seen that the state information (state) for the three states of −50°, −10°, and 10° (k=0, 1, 2) stored in the local experience memory LEM may be classified into two state clusters in the local proxy experience memory LPEM and stored as the two pieces of proxy state information (proxy state) of −45° and 45°. While the state information (state) has been configured here with only the rotated angle of the pole for the sake of convenience, it is also possible to have the state information include various different state conditions such as the position of the cart, the velocity of the cart, the angle of the pole, the velocity of the pole tip, etc. That is, various types of environment information can be included in the state information.

Also, the proxy action execution probabilities (proxy policy) corresponding to the first piece of proxy state information (−45°), from among the two pieces of proxy state information (proxy state), may be calculated as the average values of the action execution probabilities (policy) for the two states of −50° and −10°, and thus two action execution probabilities including the leftward movement probability of 0.7 (=(0.8+0.6)/2) and the rightward movement probability of 0.3 (=(0.2+0.4)/2) may be mapped and stored. For the action execution probabilities (policy) corresponding to the second piece of proxy state information (45°), since there is only the state information (state) for the 10° state, it can be seen that the proxy action execution probabilities (proxy policy) were stored with the leftward movement probability of 0.4 and the rightward movement probability of 0.6 as is mapped and stored as two action execution probabilities.

Each of the multiple agents AG1, AG2 may transmit the pieces of proxy state information (proxy state) and the corresponding proxy action execution probabilities (proxy policy) stored in the local proxy experience memory LPEM to the central server SVR.

As described above, in FIG. 3, each agent AG1, AG2 does not transmit the multiple pieces of state information (state) and their corresponding action execution probabilities (policy) stored in its local experience memory LEM as is to the central server SVR but instead may cluster the multiple pieces of state information (state) into multiple clusters, obtain a piece of proxy state information (proxy state) for each cluster, calculate proxy action execution probabilities (proxy policy) according to a pre-designated method for the multiple action execution probabilities (policy) corresponding to the pieces of state information (state) included in each of the clusters, store these in the local proxy experience memory LPEM, and transmit the pieces of proxy state information (proxy state) and the proxy action execution probabilities (proxy policy) stored in the local proxy experience memory LPEM to the central server SVR. Since only the pieces of proxy state information (proxy state) and the proxy action execution probabilities (proxy policy), of which the number corresponds to the configured number of clusters, are transmitted to the central server SVR, the amount of communication traffic can be greatly reduced.

Also, since the obtained pieces of state information (state) and their corresponding action execution probabilities (policy) are not transferred as is but rather are transferred after being converted to proxy state information (proxy state) and proxy action execution probabilities (proxy policy), this allows for the protection of the individual information of each agent AG1, AG2. In other words, since the actual state and the actual responsive actions of each of the multiple agents AG1, AG2 are not transmitted as is to the central server SVR, the individual information of the multiple agents AG1, AG2 can be protected.

In FIG. 3, the central server SVR may include a global computation unit (not shown) and a global proxy experience memory GPEM instead of a global experience memory GEM. The global experience memory GEM illustrated in FIG. 1 would store the state information (state) and action execution probabilities (policy) transmitted from each of the multiple agents AG1, AG2 and simply redistribute the stored state information (state) and action execution probabilities (policy) back to the multiple agents AG1, AG2.

In contrast, at the central server SVR of FIG. 3, when the pieces of proxy state information (proxy state) and proxy action execution probabilities (proxy policy) in numbers corresponding to the number of clusters are transferred from each of the multiple agents AG1, AG2, the global computation unit may compute global action execution probabilities (global proxy policy) according to a pre-designated method from the proxy action execution probabilities (proxy policy) corresponding to each piece of proxy state information (proxy state) transferred from the multiple agents AG1, AG2 and store the global action execution probabilities in the global proxy experience memory GPEM. The pieces of proxy state information (proxy state) together with the corresponding global action execution probabilities (global proxy policy) stored in the global proxy experience memory GPEM may be distributed to the multiple agents AG1, AG2.

That is, the central server SVR may in turn obtain global action execution probabilities (global proxy policy) from the multiple proxy action execution probabilities (proxy policy) for the proxy state information (proxy state) transferred from the multiple agents AG1, AG2, store these in the global proxy experience memory GPEM, and transfer only the stored pieces of proxy state information (proxy state) and corresponding global action execution probabilities (global proxy policy) to the multiple agents AG1, AG2, so that the amount of communication traffic associated with transmissions from the central server SVR to the multiple agents AG1, AG2 can be greatly reduced.

Although the above describes the multiple agents AG1, AG2 and the central server SVR as transferring pieces of proxy state information (proxy state), the pieces of proxy state information (proxy state) can be designated beforehand. That is, as all of the multiple agents AG1, AG2 may classify and cluster multiple pieces of state information (state) in the same manner, the proxy state information (proxy state) representing each cluster can be pre-designated at the multiple agents AG1, AG2 and the central server SVR.

Having the multiple agents AG1, AG2 and the central server SVR transmit proxy state information (proxy state) in this embodiment is simply so that the proxy state information may be used as identifiers for identifying the clusters in which the proxy action execution probabilities (proxy policy) and global action execution probabilities (global proxy policy) are included. Therefore, in certain cases, the multiple agents AG1, AG2 and the central server SVR can be configured to transmit identifiers associated with the clusters represented by the proxy state information (proxy state), with the identifiers mapped to the proxy action execution probabilities (proxy policy) and global action execution probabilities (global proxy policy). That is, transmitting cluster identifiers instead of the pieces of proxy state information (proxy state) not only can further reduce the amount of traffic but also can increase security by obscuring the meaning of the state information.

The multiple agents AG1, AG2, upon receiving the proxy state information (proxy state) and their corresponding global action execution probabilities (global proxy policy), may apply reinforced learning on the local neural network LNN based on the multiple pieces of state information (state) and corresponding action execution probabilities (policy) stored in the local experience memory LEM as well as the received pieces of proxy state information (proxy state) and corresponding global action execution probabilities (global proxy policy).

The loss estimation unit LES can perform reinforced learning by calculating a loss value based on the action execution probabilities (policy) that the local neural network LNN has estimated according to the state information (state) and the proxy state information (proxy state) and corresponding global action execution probabilities (global proxy policy) transferred from the central server SVR. Here, the loss value can be calculated as the cross-entropy loss between the action execution probabilities (policy) for the state information and the global action execution probabilities (global proxy policy).

In the distributed reinforced learning system of this embodiment, each of the multiple agents AG1, AG2 can be included in any of a variety of devices that perform individually designated functions and can learn through distributed reinforced learning to be regarded as an apparatus for distributed reinforced learning that determines the actions performed by the device as it interacts with the surrounding environment. The central server SVR can also be regarded as an apparatus for distributed reinforced learning that obtains global action execution probabilities (global proxy policy) from proxy action execution probabilities (proxy policy) transmitted from multiple agents AG1, AG2 and distributes the global action execution probabilities back to the multiple agents AG1, AG2.

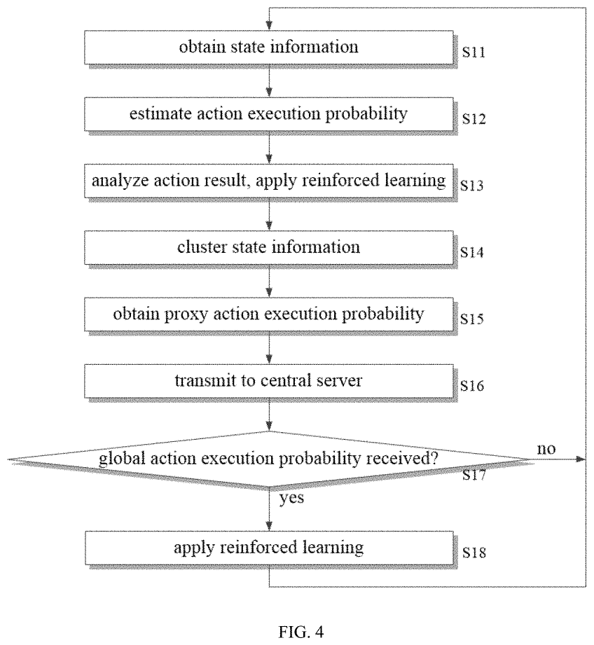

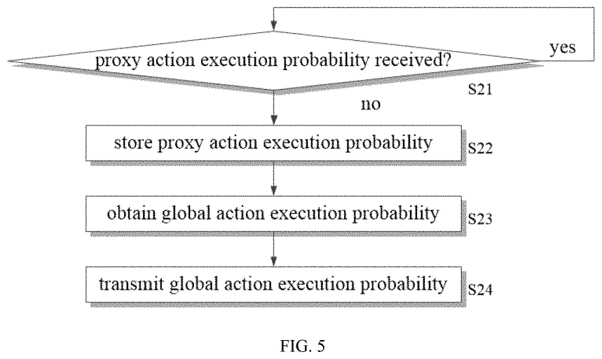

FIG. 4 and FIG. 5 illustrate a method for distributed reinforced learning according to an embodiment of the disclosure, where FIG. 4 illustrates the actions of an agent, and FIG. 5 illustrates the actions of the central server.

Referring to FIG. 4, each of the multiple agents AG1, AG2 may obtain state information (state) regarding the surrounding environment from a device (S11). According to the obtained state information (state), each agent may estimate action execution probabilities (policy), which probabilistically represent the actions that the device should execute (action), based on the pattern estimation method learned up until then and may map to each other and store the state information (state) and the estimated action execution probabilities (policy) (S12). Then, the device may execute an action based on the estimated action execution probabilities (policy), and the agent AG1, AG2 may estimate a loss value (value) from the result of the action execution to perform reinforced learning in a pre-designated manner (S13).

The pieces of state information (state) obtained during a pre-designated condition segment may be clustered according to a pre-designated method and classified into a multiple number of state clusters (S14). Here, the proxy state information (proxy state) for each of the multiple state clusters can be configured beforehand.

After the classifying into multiple state clusters, the proxy action execution probabilities (proxy policy) may be obtained by applying a pre-designated computation operation to at least one action execution probabilities (policy) mapped to at least one piece of state information (state) included in the classified state cluster (S15).

The proxy action execution probabilities (proxy policy) thus obtained may be transmitted to the central server SVR (S16). Here, the agents AG1, AG2 can also transmit the pieces of proxy state information (proxy state) corresponding to the proxy action execution probabilities (proxy policy) or identifiers from which the pieces of proxy state information (proxy state) can be identified to the central server SVR.

Afterwards, it may be determined whether or not global action execution probabilities (global proxy policy), which may be obtained by a pre-designated computation operation from the multiple proxy action execution probabilities (proxy policy) transmitted from the multiple agents, are received from the central server SVR (S17). If the global action execution probabilities (global proxy policy) are received, reinforced learning may be performed based on the received global action execution probabilities (global proxy policy) and the previously obtained action execution probabilities (policy) (S18).

Referring to FIG. 5, the central server SVR may determine whether or not proxy action execution probabilities (proxy policy) are received from at least one of the multiple agents AG1, AG2 (S21). If proxy action execution probabilities (proxy policy) are received from at least one agent, the proxy action execution probabilities (proxy policy) may be stored (S22). Together with proxy action execution probabilities (proxy policy) received previously from at least one of the agents, a computation of a pre-designated method may be applied to obtain global action execution probabilities (global proxy policy) (S23). Once the global action execution probabilities (global proxy policy) are obtained, the obtained global action execution probabilities (global proxy policy) may be transmitted to the multiple agents participating in the distributed reinforced learning (S24). Here, the central server SVR can transmit pieces of proxy state information (proxy state) corresponding to the global action execution probabilities (global proxy policy) or identifiers from which the proxy state information (proxy state) can be identified together to the agents.

A method according to an embodiment of the disclosure can be implemented as a computer program stored in a medium for execution on a computer. Here, the computer-readable medium can be an arbitrary medium available for access by a computer, where examples can include all types of computer storage media. Examples of a computer storage medium can include volatile and non-volatile, detachable and non-detachable media implemented based on an arbitrary method or technology for storing information such as computer-readable instructions, data structures, program modules, or other data, and can include ROM (read-only memory), RAM (random access memory), CD-ROM's, DVD-ROM's, magnetic tapes, floppy disks, optical data storage devices, etc.

While the present disclosure is described with reference to embodiments illustrated in the drawings, these are provided as examples only, and the person having ordinary skill in the art would understand that many variations and other equivalent embodiments can be derived from the embodiments described herein.

Therefore, the true technical scope of the present invention is to be defined by the technical spirit set forth in the appended scope of claims.

What is claimed is:

1. An apparatus for distributed reinforcement learning, the apparatus comprising:
a local neural network configured to receive state information regarding a surrounding environment and estimate an action execution probability from the state information according to a previously learned pattern estimation method, the action execution probability probabilistically representing an action to be executed;
a loss estimation unit configured to apply learning to the local neural network by estimating a loss value from the action execution probability and a global action execution probability transmitted from a central server;
a local experience memory configured to store the state information and the action execution probability estimated in correspondence to the state information, the state information and the action execution probability stored mapped to each other;
a clustering unit configured to cluster a plurality of pieces of state information stored in the local experience memory according to a pre-designated method to classify the pieces of state information into at least one state cluster having a piece of proxy state information configured beforehand, the clustering unit configured to obtain a proxy action execution probability for each state cluster from an action execution probability mapped correspondingly to each piece of state information included in the at least one state cluster; and
a local proxy memory configured to map and store the proxy state information and proxy action execution probability corresponding to each of the at least one state cluster for transmitting to the central server.

2. The apparatus for distributed reinforcement learning according to claim 1, wherein the clustering unit obtains the proxy action execution probability by calculating a statistics value in a pre-designated manner for action execution probabilities mapped correspondingly to each of at least one piece of state information included in each of the at least one state cluster.

3. The apparatus for distributed reinforcement learning according to claim 1, wherein the apparatus transmits the proxy action execution probabilities stored during a pre-designated condition segment together with the mapped proxy state information to the central server.

4. The apparatus for distributed reinforcement learning according to claim 1, wherein the apparatus transmits an identifier of the at least one state cluster together with the proxy action execution probability to the central server, the identifier configured to represent the proxy state information.

5. The apparatus for distributed reinforcement learning according to claim 1, wherein the global action execution probability is obtained by the central server as a statistics value calculated in a pre-designated manner for a plurality of proxy action execution probabilities obtained by a plurality of distributed reinforcement learning apparatuses in correspondence to each of at least one cluster, and the global action execution probability is transmitted to the plurality of distributed reinforcement learning apparatuses.

6. An apparatus for distributed reinforcement learning, the apparatus comprising:
a global experience memory configured to receive and store at least one piece of proxy state information and at least one proxy action execution probability, the at least one piece of proxy state information and the at least one proxy action execution probability received from a plurality of agents, the at least one piece of proxy state information configured in correspondence to at least one pre-designated state cluster, the at least one proxy action execution probability mapped in correspondence to each of the at least one piece of proxy state information;
a global computation unit configured to compute a global action execution probability in a pre-designated manner from the at least one proxy action execution probability mapped to each of the at least one piece of proxy state information stored in the global experience memory; and
a global proxy experience memory configured to map and store the computed global action execution probability for redistributing transmission to each of the plurality of agents, the global action execution probability stored mapped correspondingly to the at least one piece of proxy state information.

7. The apparatus for distributed reinforcement learning according to claim 6, wherein the global computation unit obtains the global action execution probability by calculating a statistics value in a pre-designated manner for a plurality of proxy action execution probabilities mapped to each of the at least one piece of proxy state information.

8. The apparatus for distributed reinforcement learning according to claim 6, wherein the apparatus transmits the global action execution probabilities stored during a pre-designated condition segment together with the mapped proxy state information to the plurality of agents.

9. The apparatus for distributed reinforcement learning according to claim 6, wherein the apparatus, after receiving at least one identifier respectively representing the at least piece of proxy state information together with the at least one proxy action execution probability mapped to the at least one identifier, transmits the global action execution probability and an identifier mapped thereto to the plurality of agents.

10. The apparatus for distributed reinforcement learning according to claim 6, wherein the at least one piece of proxy state information is obtained by clustering pieces of state information in a pre-designated manner to classify the pieces of state information into at least one state cluster and designating a piece of state information to represent each of the at least one state clusters, the pieces of state information obtained by each of a plurality of agents for a surrounding environment, and
the at least one proxy action execution probability is obtained from action execution probabilities mapped to corresponding pieces of state information included in the at least one state cluster after the action execution probabilities are estimated and mapped by each of the plurality of agents according to a previously learned pattern estimation method, the action execution probabilities probabilistically expressing actions to be executed.

11. A method for distributed reinforcement learning, the method comprising:
receiving state information and estimating an action execution probability from the state information according to a previously learned pattern estimation method, the state information representing a state of a surrounding environment, the action execution probability probabilistically representing an action to be executed;
learning a pattern estimation method for estimating the action execution probability by determining a loss value from the action execution probability and a global action execution probability transmitted from a central server;
storing the state information and the action execution probability corresponding to the state information in a mapped form;
clustering a plurality of pieces of state information in a pre-designated manner to classify the plurality of pieces of state information into at least one state cluster having a piece of proxy state information configured therefor beforehand, and obtaining a proxy action execution probability for each state cluster from action execution probabilities mapped correspondingly to pieces of state information included in the at least one state cluster; and
storing the proxy state information and proxy action execution probability corresponding to each of the at least one state cluster in a mapped form for transmitting to the central server.

12. The method for distributed reinforcement learning according to claim 11, wherein the obtaining of the proxy action execution probability comprises:
calculating a statistics value in a pre-designated manner for the action execution probabilities mapped correspondingly to at least one piece of state information included in each of the at least one state cluster to obtain the proxy action execution probability.

13. The method for distributed reinforcement learning according to claim 11, wherein proxy action execution probabilities stored during a pre-designated condition segment and mapped pieces of proxy state information are transmitted together to the central server.

14. The method for distributed reinforcement learning according to claim 11, wherein an identifier of at least one state cluster is transmitted together with the proxy action execution probability to the central server, the identifier configured to represent the proxy state information.

15. The method for distributed reinforcement learning according to claim 11, wherein the global action execution probability is obtained and transmitted by the central server as a statistics value calculated in a pre-designated manner for a plurality of proxy action execution probabilities obtained correspondingly by a plurality of distributed reinforcement learning methods in correspondence to each of at least one cluster.

16. A method for distributed reinforcement learning, the method comprising:
receiving and storing at least one piece of proxy state information configured in correspondence to at least one pre-designated state cluster and at least one proxy action execution probability mapped in correspondence to the at least one piece of proxy state information, the at least one piece of proxy state information and the at least one proxy action execution probability received from a plurality of agents;
computing a global action execution probability in a pre-designated manner from the stored at least one proxy action execution probability mapped correspondingly to the at least one piece of proxy state information; and
storing the global action execution probability computed for each of the at least one piece of proxy state information in a mapped form for redistributing transmission to each of the plurality of agents.

17. The method for distributed reinforcement learning according to claim 16, wherein the computing of the global action execution probability comprises:
calculating a statistics value in a pre-designated manner for a plurality of proxy action execution probabilities mapped correspondingly to the at least one piece of proxy state information to obtain the global action execution probability.

18. The method for distributed reinforcement learning according to claim 16, wherein the global action execution probability stored during a pre-designated condition segment and mapped pieces of proxy state information are transmitted together to the plurality of agents.

19. The method for distributed reinforcement learning according to claim 16, wherein, after at least one identifier respectively representing the at least piece of proxy state information together with the at least one proxy action execution probability mapped to the at least one identifier are received, the global action execution probability and an identifier mapped thereto are transmitted to the plurality of agents.

20. The method for distributed reinforcement learning according to claim 16, wherein the at least one piece of proxy state information is obtained by clustering pieces of state information in a pre-designated manner to classify the pieces of state information into at least one state cluster and designating a piece of state information to represent each of the at least one state clusters, the pieces of state information obtained by each of a plurality of agents for a surrounding environment, and
the at least one proxy action execution probability is obtained from action execution probabilities mapped to corresponding pieces of state information included in the at least one state cluster after the action execution probabilities are estimated and mapped by each of the plurality of agents according to a previously learned pattern estimation method, the action execution probabilities probabilistically expressing actions to be executed.
